(19) United States
(12) Patent Application Publication
(10) Pub. No.: US 2018/0239831 A1
(43) Pub. Date: Aug. 23, 2018

(54) METHODS AND SYSTEMS FOR SOCIAL NETWORKING BASED ON NUCLEIC ACID SEQUENCES

(71) Applicant: John Boyce, Bridgewater, MA (US)

(72) Inventor: John Boyce, Bridgewater, MA (US)

(21) Appl. No.: 15/901,683

(22) Filed: Feb. 21, 2018

Related U.S. Application Data
(63) Continuation of application No. 14/695,307, filed on Apr. 24, 2015, now abandoned.
Application No. 14/695,307 is a continuation of application No. 14/073,461, filed on Nov. 6, 2013, now abandoned.
Application No. 14/073,461 is a continuation of application No. 12/920,152, filed on Jan. 3, 2011, now abandoned.
(60) Provisional application No. 61/067,616, filed on Feb. 29, 2008.

(51) Int. Cl. G06F 17/30; G06F 19/28; G06Q 10/10; G06F 19/22

(52) U.S. Cl. CPC G06F 17/30867; G06F 19/28; G06Q 10/10; G06F 19/18; G06F 17/30424; G06F 17/3053; G06F 19/22

(57) ABSTRACT

The invention relates to methods and systems for social networking based on profile characteristics (e.g., including phenotypic information) and/or genetic sequence information.

### RELATED APPLICATIONS

This application is a continuation of U.S. application Ser. No. 14/695,307 filed on Apr. 24, 2015, which is a continuation of U.S. application Ser. No. 14/073,461 filed on Nov. 6, 2013, which is is a continuation of U.S. application Ser. No. 12/920,152 filed on Jan. 3, 2011, which is a National Stage of PCT/US09/035673 filed on Mar. 2, 2009, which claims the benefit of priority to U.S. Provisional Patent Application No. 61/067,616, filed on Feb. 29, 2008, all of which applications are hereby incorporated by reference in their entirety.

### FIELD OF THE INVENTION

The invention relates to methods and systems for social networking based on nucleic acid sequences.

### BACKGROUND OF THE INVENTION

Conventionally, people have networked with one another by joining clubs, attending social events and parties, meeting other people through friends, and so forth. The Internet has made keeping in touch with friends and acquaintances more convenient for many people by, for example, email, web logs (“blogs”), chat rooms, bulletin boards, and instant messaging. For other people, the Internet provides a social forum for networking and meeting new people.

Many people use the Internet as the principal way in which they meet new friends and remain in touch with existing friends. Thus, the Internet provides a medium for a complex array of interactions between vast numbers of individuals.

In order to facilitate communications between numerous individuals, various social networking websites have developed in recent years. The overarching accomplishment of these websites is that it allows users to reach out and feel connected with individuals similar to themselves. Social networking websites also allow users to provide basic information to keep their friends and others informed about a wide variety of topics, including common experiences and interests. These websites can also provide organizational tools and forums for allowing these individuals to interact with one another via the websites.

The popularity of these sites has grown enormously, with the most popular social networking site, My Space yielding a 367% growth in users from April '05 to April '06. Given the social networking user's desire to connect with other similar individuals who may share common interests and ways of thinking, the user will need to share personal data about himself/herself in order to achieve those connections. However, many users are leery about providing personal information via the Internet. Many users prefer to limit communications to specific groups of other users, for example.

Even though individuals are concerned about privacy, they are willing to share personal information about themselves in certain forums. Social networking sites provide a forum by which users share a vast amount of information, about themselves, in order to connect with other users and/or members of groups who share similar interests or are similar situations. Users of social networking sites share not only their personal information, but also share information about their families, such as, likes/dislikes, medical conditions, and response to various treatments. These users reach out to other users who are in similar situations in order to form communities and support groups. Pioneering technologies such as nucleic acid arrays and single molecule DNA sequencing technology allow scientists to make use of genetic information at a far greater level than ever before. Held within the complex structure of genomic DNA lies the potential to identify, diagnose, or treat diseases such as cancer, Alzheimer disease or alcoholism. Interrogation of genomic DNA and identification of causative mutations that are responsible for specific disease states have long been a dream of the scientific community, and as the technology that enables this interrogation to occur becomes more affordable and more high-throughput, the notion of finding the genetic cause of disease states becomes more plausible.

Recent efforts in the scientific community, such as the publication of the draft sequence of the human genome in February 2001, have changed the dream of genome exploration into a reality. Genome-wide assays, however, must contend with the complexity of genomes; the human genome, for example, is estimated to have a complexity of 3×10⁹ base pairs. Novel methods of sample preparation and sample analysis that reduce complexity may provide for the fast and cost effective exploration of complex samples of nucleic acids, particularly genomic DNA. In order to pinpoint mutations in nucleic acid that may be responsible for contributing to disease states, researchers compare the frequency of mutations in a case group versus the frequency of those mutations in a control group. The number of individuals needed in the case and control groups, in order to properly power a genetic study and provide meaningful associations between a specific mutation and a disease state, is predicated by factors such as the allele frequency of a mutation in the population, the prevalence of the disease in the broader population, and the relative risk of that mutation. The majority of the genetic association studies performed are underpowered as the number of individuals in a study needed, to correctly power the study—and thus pinpoint the causative association, is often cost prohibitive and hard to obtain due to regulatory compliance.

As new tools, so called next generation sequencing instruments, become available to sequence the human genome the National Institutes of Health (NIH) has created initiatives to drive the cost down of sequencing a human genome. One of the first of these initiatives is the thousand dollar genome initiative, whereby the NIH has awarded over ten million dollars in grant money to companies and institutes aiming to develop tools that will enable sequencing a human genome for $1,000 USD. Another such recently announced project is the 1,000 Genomes Project, an ambitious effort that will involve sequencing the genomes of at least 1,000 people from around the world to create the most detailed and medically useful picture to date of human genetic variation. The project will receive major support from the Wellcome Trust Sanger Institute in Hinxton, England, the Beijing Genomics Institute, Shenzhen (BGI Shenzhen) in China and the National Human Genome Research Institute (NHGRI), part of the National Institutes of Health (NIH).

Craig Venter, a pioneer in the field of genome sequencing and the former CEO of Celera (the first company to sequence the human genome), has stated that the cost of sequencing the human genome with today's technology would be less than half a million dollars. “But if you extrapolate from when we did the first genome in '95 to today, within five years we should be down into the thousand dollar range for a genome.” Based on the foregoing, it is a virtual certainly that in the near future it will be possible to profile key genes of newborns.

Users of social networking sites are always searching for criteria to identify with others, and thus feel connected to a community. One's genetic code will provide the most stringent criteria when determining similarity. For example, a user may conduct a broad search for individuals who are most similar to himself/herself and create a community of these users. This community may then compare notes on health related experiences, interests, and talents. As companies continue to improve sequencing technologies and make them commercially available and affordable, the present invention provides a novel means by which this technology may be utilized allowing individuals to network based on their profile characteristics (e.g., including phenotypic information) and/or genetic sequence information. The invention will also provide a database of tens of millions of users who have uploaded both their genotypic and phenotypic information. This information will be used to properly power association studies, with case and control groups numbering in the tens of thousands, and will help to pinpoint the causative mutations responsible for disease.

### SUMMARY OF THE INVENTION

The present invention provides methods and systems of social networking based on profile characteristics (including, for example, phenotypic information) and/or genetic sequence information (including, for example, a nucleic acid sequence).

In certain embodiments, the invention relates to a method of social networking based on nucleic acid sequence analysis comprising the steps of:
(a) storing in a data storage system nucleic acid sequence data and user profile data for each of a plurality of users of a social networking community;
(b) receiving a query from one of said users of said social networking community for identifying one or more other users of said social networking community having given user profile characteristics and nucleic acid sequence characteristics;
(c) identifying a set of one or more users having the given user profile characteristics;
(d) of said set of one or more users identified in (c), identifying a subset of users having said given nucleic acid sequence characteristics; and
(e) transmitting information on said subset of users to the user submitting the query.

In certain embodiments, the invention relates to any one of the aforementioned methods, wherein said nucleic acid is DNA or RNA.

In certain embodiments, the invention relates to any one of the aforementioned methods, wherein the given user profile characteristics and nucleic acid sequence characteristics comprise user profile characteristics and nucleic acid sequence characteristics matching those of the user submitting the query.

In certain embodiments, the invention relates to any one of the aforementioned methods, wherein the given user profile characteristics and nucleic acid sequence characteristics comprise user profile characteristics and nucleic acid sequence characteristics matching the search criteria input from the user.

In certain embodiments, the invention relates to any one of the aforementioned methods, wherein the given user profile characteristics and nucleic acid sequence characteristics comprise user profile characteristics matching those of the user submitting the query and nucleic acid sequence characteristics not matching those of the user submitting the query.

In certain embodiments, the invention relates to any one of the aforementioned methods, wherein the given user profile characteristics and nucleic acid sequence characteristics comprise user profile characteristics matching the search criteria input from the user and nucleic acid sequence characteristics not matching the search criteria input from the user.

In certain embodiments, the invention relates to any one of the aforementioned methods, further comprising facilitating communication between the user submitting a query and the subset of users.

In certain embodiments, the invention relates to any one of the aforementioned methods, wherein facilitating communication comprises messaging through a website hosting the social networking community.

In certain embodiments, the invention relates to any one of the aforementioned methods, wherein said subset of users is rank ordered based on nucleic acid sequence characteristics.

In certain embodiments, the invention relates to any one of the aforementioned methods, wherein the query is based on phenotypic information.

In certain embodiments, the invention relates to a social networking system based on nucleic acid sequence analysis comprising:

a data storage system for storing nucleic acid sequence data and user profile data for each of a plurality of users of a social networking community; and

a computer server for (a) receiving over a computer network a query from one of said users of said social networking community for identifying one or more other users of said social networking community having given user profile characteristics and nucleic acid sequence characteristics; (b) identifying in the data storage system a set of one or more users having the given user profile characteristics; (c) identifying a subset of users having said given nucleic acid sequence characteristics from said set of one or more users; and (d) transmitting information on said subset of users to the user submitting the query.

In certain embodiments, the invention relates to any one of the aforementioned social networking systems, wherein said nucleic acid is DNA or RNA.

In certain embodiments, the invention relates to any one of the aforementioned social networking systems, wherein the given user profile characteristics and nucleic acid sequence characteristics comprise user profile characteristics and nucleic acid sequence characteristics matching those of the user submitting the query.

In certain embodiments, the invention relates to any one of the aforementioned social networking systems, wherein the given user profile characteristics and nucleic acid sequence characteristics comprise user profile characteristics and nucleic acid sequence characteristics matching the search criteria input from the user.

In certain embodiments, the invention relates to any one of the aforementioned social networking systems, wherein the given user profile characteristics and nucleic acid sequence characteristics comprise user profile characteristics matching those of the user submitting the query and nucleic acid sequence characteristics not matching those of the user submitting the query.

In certain embodiments, the invention relates to any one of the aforementioned social networking systems, wherein the given user profile characteristics and nucleic acid sequence characteristics comprise user profile characteristics matching the search criteria input from the user and nucleic acid sequence characteristics not matching the search criteria input from the user.

In certain embodiments, the invention relates to any one of the aforementioned social networking systems, wherein said server facilitates communication between the user submitting a query and the subset of users.

In certain embodiments, the invention relates to any one of the aforementioned social networking systems, wherein said server facilitates messaging through a website hosted by the server.

In certain embodiments, the invention relates to any one of the aforementioned social networking systems, wherein said subset of users are rank ordered based on nucleic acid sequence characteristics.

In certain embodiments, the invention relates to any one of the aforementioned social networking systems, wherein the query is based on phenotypic information.

In certain embodiments, the invention relates to a social networking system based on nucleic acid sequence analysis comprising:

a repository for nucleic acid sequence data and user profile data for each of a plurality of users of a social networking community; and

a computer server for (a) receiving over a computer network a query from one of said users of said social networking community for identifying one or more other users of said social networking community having given user profile characteristics and nucleic acid sequence characteristics; (b) identifying in the data storage system a set of one or more users having the given user profile characteristics; (c) identifying a subset of users having said given nucleic acid sequence characteristics from said set of one or more users; and (d) transmitting information on said subset of users to the user submitting the query.

In certain embodiments, the invention relates to any one of the aforementioned social networking systems, wherein said nucleic acid is DNA or RNA.

In certain embodiments, the invention relates to any one of the aforementioned social networking systems, wherein the given user profile characteristics and nucleic acid sequence characteristics comprise user profile characteristics and nucleic acid sequence characteristics matching those of the user submitting the query.

In certain embodiments, the invention relates to any one of the aforementioned social networking systems, wherein the given user profile characteristics and nucleic acid sequence characteristics comprise user profile characteristics and nucleic acid sequence characteristics matching the search criteria input from the user.

In certain embodiments, the invention relates to any one of the aforementioned social networking systems, wherein the given user profile characteristics and nucleic acid sequence characteristics comprise user profile characteristics matching those of the user submitting the query and nucleic acid sequence characteristics not matching those of the user submitting the query.

In certain embodiments, the invention relates to any one of the aforementioned social networking systems, wherein the given user profile characteristics and nucleic acid sequence characteristics comprise user profile characteristics matching the search criteria input from the user and nucleic acid sequence characteristics not matching the search criteria input from the user.

In certain embodiments, the invention relates to any one of the aforementioned social networking systems, wherein said server facilitates communication between the user submitting a query and the subset of users.

In certain embodiments, the invention relates to any one of the aforementioned social networking systems, wherein said server facilitates messaging through a website hosted by the server.

In certain embodiments, the invention relates to any one of the aforementioned social networking systems, wherein said subset of users are rank ordered based on nucleic acid sequence characteristics.

In certain embodiments, the invention relates to any one of the aforementioned social networking systems, wherein the query is based on phenotypic information.

For example, the instant invention provides a method whereby an individual may create a username and password on a website, upload a nucleic acid sequence on a server, run a query, obtain a plurality of sequences from a cohort based upon the query, and compare the individual's nucleic acid sequence to one or more individual's nucleic acid sequences in the cohort.

In one embodiment, the invention is directed to a method of social networking based on nucleic acid sequence analysis comprising the steps of: (a) storing a nucleic acid sequence on a computer; (b) running a query; (c) obtaining a cohort based upon the query; and (d) comparing an individual's nucleic acid sequence to one or more individuals' nucleic acid sequence in the cohort. On another embodiment, the nucleic acid is DNA or RNA. In yet another embodiment, an algorithm compares an individual's nucleic acid to a consensus sequence.

In one embodiment, the method includes the step of contacting one or more individuals from the generated result in step (d) by a form of messaging through the website. In another aspect, the method comprises the step of contacting one or more individuals by a form of messaging through the website. In yet another aspect, step (b) further comprises a query based on phenotypic or profile information.

In another embodiment, the method includes the step of entering and registering on a website by creating an username and password. In one embodiment, the method includes the step of running a software program algorithm during steps (c)-(d).

In still another embodiment, the invention is directed to a method of social networking comprising the steps of: (a) matching a phenotypic trait from a first individual to the same phenotypic trait from one or more different individuals; (b) comparing a nucleic acid sequence from a first individual to a nucleic acid sequence from one or more different individuals; (c) running an algorithm based on the results from step (a) and the results from step (b); and (d) returning a generated result based on the phenotypic trait in step (a) and the nucleic acid sequence in step (b). In still another embodiment, the method further comprises the step of contacting one or more individuals from the generated result in step (d) by a form of messaging through the website.

In another aspect, the invention provides a method for social networking based on a nucleic acid sequence analysis, the method comprising the steps of: (a) uploading a nucleic acid sequence to an electronic storage repository; (b) running an algorithm based on the nucleic acid sequence of an individual user or a group of users of a social networking community; and (c) reporting a result to the user or group of users of the social networking community, based on the analysis of the nucleic acid sequence. In one embodiment, the algorithm matches a user to another user, group of users, or category of users of the social network, based on a nucleic acid sequence. In another embodiment, an algorithm matches a group of users to an individual user, a plurality of users, a different group, or a different category of users of the social network, based on a nucleic acid sequence. In still another embodiment, an algorithm resides locally on the computer of a user of the social networking community. In yet another embodiment, an algorithm resides on a server for the social network. In still another embodiment, the results are returned to a local computer of the user. In one embodiment, the results are displayed on a webpage. In another embodiment, the user uploads a nucleic acid sequence to an electronic repository, thereby associating the nucleic acid sequence with a webpage. In still another embodiment, the results are rank ordered, based on a nucleic acid sequence. In an embodiment, the nucleic acid sequence is DNA, RNA, or a combination of both.

In one embodiment, the invention provides a method of social networking further comprising the step of said user contacting one or more individuals from the generated result in step (c) by a form of messaging through the website.

In yet another embodiment, the invention is directed to a computer system that is capable of performing the methods of the invention. In another embodiment, the invention provides a computer system having at least one user interface including at least one output device and at least one input device, a method for social networking based on nucleic acid sequence comprising: (a) creating an account on a website by a user; (b) uploading a user's nucleic acid sequence; (c) running a query by the user for a phenotypic trait; (d) obtaining a cohort of data based upon the query for the phenotypic trait; and (e) comparing the user's nucleic acid sequence to one or more individuals' nucleic acid sequence in the cohort by an algorithm.

Other embodiments of the invention will be apparent based on the discussion below.

### BRIEF DESCRIPTION OF THE DRAWINGS

FIG. 1 illustrates a schematic diagram of an exemplary environment for social networking based on a nucleic acid sequence.

FIG. 2 illustrates a schematic diagram of another exemplary environment for social networking.

FIG. 3 illustrates a schematic diagram of an exemplary gene selection software algorithm.

FIG. 4 illustrates a diagram of an exemplary method of social networking.

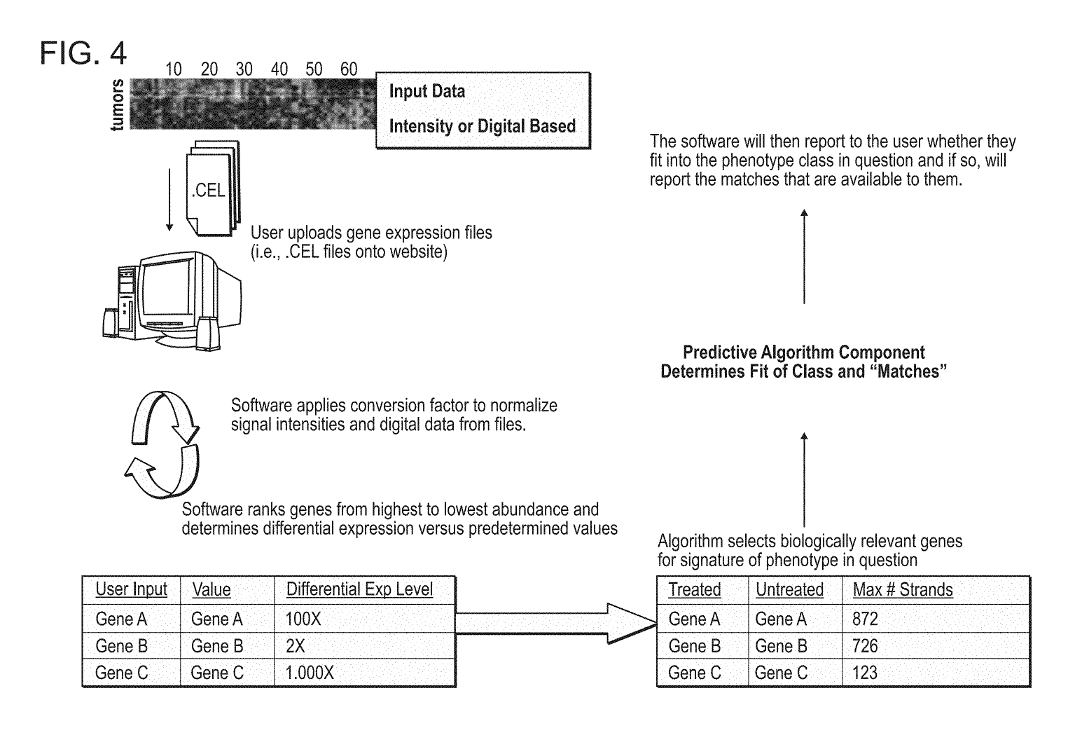

FIG. 5 illustrates a picture of testing single nucleotide polymorphisms for association by direct and indirect methods.

### DETAILED DESCRIPTION OF THE INVENTION

### I. Overview

In this section certain embodiments of the invention are described in detail with reference to the accompanying drawings. The disclosed description, methods, and examples facilitate social networking based on a nucleic acid sequence.

In the interest of clarity, not all of the routine features of the implementations described herein are shown and described. It will, of course, be appreciated that in the development of any such actual implementation, numerous implementation-specific decisions must be made in order to achieve the specific goals, such as compliance with application- and business-related constraints, and that these specific goals will vary from one implementation to another and from one individual to another. Moreover, it will be appreciated that such a development effort might be complex and time-consuming, but would nevertheless be a routine undertaking for those of ordinary skill in the art having the benefit of this disclosure.

### II. Definitions

### Technology Definitions

As used herein, the term “Internet” generally means a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations that may be made in the future, including changes and additions to existing standard protocols. The term refers to the so-called world wide web that are networks connected to each other using the Internet protocol (IP) and other similar protocols.

As used herein, the term “network” is for descriptive purposes only. Although the description may refer to terms commonly used in describing particular public networks such as the Internet, the description and concepts equally apply to other public and private computer networks, including systems having architectures dissimilar. For example, and without limitation thereto, the system and methods of the present invention can find application in public as well as private networks, such as a closed university social system, or the private network of a company. References to a network, unless provided otherwise, can include one or more intranets and/or the internet.

As used herein, the term “processor” generally can be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

A processor can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices.

The device(s) or computer systems that integrate with the processor(s) can include, for example, a personal computer(s), workstation, personal digital assistant (PDA), handheld device such as cellular telephone, smart phone, laptop, or another device capable of being integrated with a processor(s) that can operate as provided herein. Accordingly, the devices provided herein are not exhaustive and are provided for illustration and not limitation.

As used herein, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

### Biological Definitions

As used herein, the term “nucleic acid,” “nucleic acid sequence characteristics,” or “sequence information” includes any polymer or oligomer of pyrimidine and purine bases, preferably cytosine, thymine, and uracil, and adenine and guanine, respectively. See Albert L. Lehninger, Principles of Biochemistry, p. 793-800 (Worth Pub. 1982) which is herein incorporated in its entirety for all purposes). The term “nucleic acid” includes any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally occurring sources or may be artificially or synthetically produced. In addition, the terms nucleic acids, nucleic acid sequence characteristics or sequence information as used by the present invention may include DNA or RNA, or a mixture thereof, and may exist permanently or transitionally in single-stranded or double-stranded form, including homoduplex, heteroduplex, and hybrid states.

As used herein, the term “oligonucleotide” or “polynucleotide” generally means a nucleic acid ranging from at least 2, preferably at least 8, 15 or 20 nucleotides in length, but may be up to 50, 100, 1000, or 5000 nucleotides long or a compound that specifically hybridizes to a polynucleotide.

As used herein, the term “polynucleotide” generally means a sequence of deoxyribonucleic acid (DNA) or ribonucleic acid (RNA) or mimetics thereof which may be isolated from natural sources, recombinantly produced or artificially synthesized. Nontraditional base pairing such as Hoogsteen base pairing which has been identified in certain tRNA molecules and postulated to exist in a triple helix is also contemplated. The terms “polynucleotide” and “oligonucleotide” are used interchangeably in this application.

As used herein, the term “genome” generally means all the genetic material of an organism. In some instances, the term genome may refer to the chromosomal DNA. Genome may be multichromosomal such that the DNA is cellularly distributed among a plurality of individual chromosomes. For example, in humans there are 22 pairs of chromosomes plus a gender associated XX or XY pair. DNA derived from the genetic material in the chromosomes of a particular organism is genomic DNA. The term genome may also refer to genetic materials from organisms that do not have chromosomal structure. In addition, the term genome may refer to mitochondrial DNA.

As used herein, the term “genomic library” generally means a collection of DNA fragments representing the whole or a portion of a genome. Frequently, a genomic library is a collection of clones made from a set of randomly generated, sometimes overlapping DNA fragments representing the entire genome or a portion of the genome of an organism.

As used herein, the term “chromosome” generally means the heredity-bearing gene carrier of a cell which is derived from chromatin and which comprises DNA and protein components (especially histones). The conventional internationally recognized individual human genome chromosome numbering system is employed herein. The size of an individual chromosome can vary from one type to another within a given multi-chromosomal genome and from one genome to another. In the case of the human genome, the entire DNA mass of a given chromosome is usually greater than about 100,000,000 base pairs (bp). For example, the size of the entire human genome is about 3×10⁹ bp. The largest chromosome, chromosome no. 1, contains about 2.4×10⁸ bp while the smallest chromosome, chromosome no. 22, contains about 5.3×10⁷ bp.

As used herein, the term “chromosomal region” generally means a portion of a chromosome. The actual physical size or extent of any individual chromosomal region can vary greatly. The term “region” is not necessarily definitive of a particular one or more genes because a region need not take into specific account the particular coding segments (exons) of an individual gene.

As used herein, the term “allele” generally means one specific form of a genetic sequence (such as a gene) within a cell, an individual or within a population, the specific form differing from other forms of the same gene in the sequence of at least one, and frequently more than one, variant sites within the sequence of the gene. The sequences at these variant sites that differ between different alleles are generally termed “variances”, “polymorphisms”, or “mutations.” At each autosomal specific chromosomal location or “locus” an individual possesses two alleles, one inherited from one parent and one from the other parent, for example one from the mother and one from the father. An individual is “heterozygous” at a locus if it has two different alleles at that locus. An individual is “homozygous” at a locus if it has two identical alleles at that locus.

As used herein, the term “polymorphism” generally means the occurrence of two or more genetically determined alternative sequences or alleles in a population.

As used herein, the term “polymorphic marker” generally means the locus at which divergence occurs. Preferred markers have at least two alleles, each occurring at a frequency of preferably greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, single nucleotide polymorphisms (SNPs) variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wild-type form. A diallelic polymorphism has two forms. A triallelic polymorphism has three forms. A polymorphism between two nucleic acids can occur naturally, or be caused by exposure to or contact with chemicals, enzymes, or other agents, or exposure to agents that cause damage to nucleic acids, for example, ultraviolet radiation, mutagens or carcinogens.

As used herein, the term “single nucleotide polymorphism” (SNP) generally means the position at which two alternative bases occur at appreciable frequency (>1%) in a given population. SNPs are the most common type of human genetic variation. A polymorphic site is frequently preceded by and followed by highly conserved sequences (e.g., sequences that vary in less than 1/100 or 1/1000 members of the populations).

A SNP may arise due to substitution of one nucleotide for another at the polymorphic site. As used herein, the term “transition” generally means the replacement of one purine by another purine or one pyrimidine by another pyrimidine. As used herein, the term “transversion” generally means the replacement of a purine by a pyrimidine or vice versa. SNPs can also arise from a deletion of a nucleotide or an insertion of a nucleotide relative to a reference allele.

As used herein, the term “genotyping” generally means the determination of the genetic information an individual carries at one or more positions in the genome. For example, genotyping may comprise the determination of which allele or alleles an individual carries for a single SNP or the determination of which allele or alleles an individual carries for a plurality of SNPs. For example, a particular nucleotide in a genome may be an A in some individuals and a C in other individuals. Those individuals who have an A at the position have the A allele and those who have a C have the C allele. In a diploid organism the individual will have two copies of the sequence containing the polymorphic position so the individual may have an A allele and a C allele or alternatively two copies of the A allele or two copies of the C allele. Those individuals who have two copies of the C allele are homozygous for the C allele, those individuals who have two copies of the A allele are homozygous for the C allele, and those individuals who have one copy of each allele are heterozygous. The array may be designed to distinguish between each of these three possible outcomes. A polymorphic location may have two or more possible alleles and the array may be designed to distinguish between all possible combinations.

As used herein, the term “genetic map” generally means a map that presents the order of specific sequences on a chromosome. A genetic map may express the positions of genes relative to each other without a physical anchor on the chromosome. The distance between markers is typically determined by the frequency of recombination, which is related to the relative distance between markers. Genetic map distances are typically expressed as recombination units or centimorgans (cM). The physical map gives the position of a marker and its distance from other genes or markers on the same chromosome in base pairs and related to given positions along the chromosome. See, Color Atlas of Genetics, Ed. Passarge, Thieme, New York, N.Y. (2001), which is incorporated by reference. Genetic variation refers to variation in the sequence of the same region between two or more individuals.

Normal cells that are heterozygous at one or more loci may give rise to tumor cells that are homozygous at those loci. This loss of heterozygosity may result from structural deletion of normal genes or loss of the chromosome carrying the normal gene, mitotic recombination between normal and mutant genes, followed by formation of daughter cells homozygous for deleted or inactivated (mutant) genes; or loss of the chromosome with the normal gene and duplication of the chromosome with the deleted or inactivated (mutant) gene.

As used herein, the term “linkage disequilibrium” or “allelic association” generally means the preferential association of a particular allele or genetic marker with a specific allele, or genetic marker at a nearby chromosomal location more frequently than expected by chance for any particular allele frequency in the population. For example, if locus X has alleles a and b, which occur at equal frequency, and linked locus Y has alleles c and d, which occur at equal frequency, one would expect the combination ac to occur at a frequency of 0.25. If ac occurs more frequently, then alleles a and c are in linkage disequilibrium. Linkage disequilibrium may result, for example, because the regions are physically close, from natural selection of certain combination of alleles or because an allele has been introduced into a population too recently to have reached equilibrium with linked alleles. A marker in linkage disequilibrium can be particularly useful in detecting susceptibility to disease (or other phenotype) notwithstanding that the marker does not cause the disease. For example, a marker (X) that is not itself a causative element of a disease, but which is in linkage disequilibrium with a gene (including regulatory sequences) (Y) that is a causative element of a phenotype, can be detected to indicate susceptibility to the disease in circumstances in which the gene Y may not have been identified or may not be readily detectable.

As used herein, the term “target sequence,” “target nucleic acid,” or “target” generally refers to a nucleic acid of interest. The target sequence may or may not be of biological significance. Typically, though not always, it is the significance of the target sequence which is being studied in a particular experiment. As non-limiting examples, target sequences may include regions of genomic DNA which are believed to contain one or more polymorphic sites, DNA encoding or believed to encode genes or portions of genes of known or unknown function, DNA encoding or believed to encode proteins or portions of proteins of known or unknown function, DNA encoding or believed to encode regulatory regions such as promoter sequences, splicing signals, polyadenylation signals, etc. In many embodiments a collection of target sequences comprising one or more SNPs is assayed. One of skill in the art will recognize that genomic DNA in humans and related primates is double stranded. Each SNP thus represents two complementary strands. The polymorphic position represents a base pair, for example, if the allele on one strand is a G, the allele on the opposite strand is a C. In addition to the polymorphic position, there is also sequence that is upstream and downstream, or 5′ of and 3′ of the SNP position.

As used herein the term matching includes profile characteristics of one of more users that are alike or similar. In addition, the term matching, as used herein, may include a comparison of one or more nucleic acid sequence characteristics (e.g., sequence information) by, for example, an alignment. Matched sequences may have sequence identity or homology of 100%, 99%, 98%, 97%, 96% 95%, 94%, 93%, 92%, 91% 90%, 89%, 88%, 87%, 86%, 85%, 84%, 83%, 82%, 81%, 80%, 75%, 70%, 65%, 60%, 55%, 50%, 45%, 40%, 35%, 30%, 25%, 20%, 15%, 10%, or 5%. Moreover, matched sequence information may also include corresponding sequence identity to a genomic reference set.

### III. Methods of Use

One aspect of the present invention relates to a method of social networking comprising the steps of: (a) storing in a data storage system nucleic acid sequence data and user profile data for each of a plurality of users of a social networking community; (b) receiving a query from one of said users of said social networking community for identifying one or more other users of said social networking community having given user profile characteristics and nucleic acid sequence characteristics; (c) identifying a set of one or more users having the given user profile characteristics; (d) of said set of one or more users identified in (c), identifying a subset of users having said given nucleic acid sequence characteristics; and (e) transmitting information on said subset of users to the user submitting the query.

### (a) Individual Account

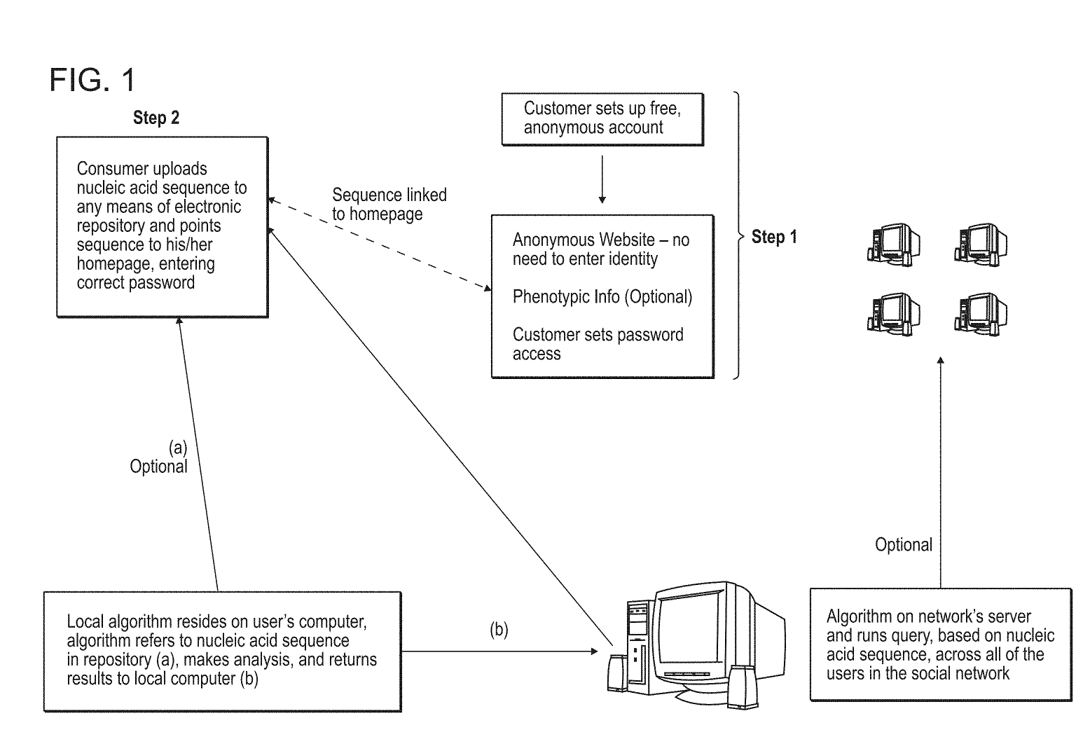

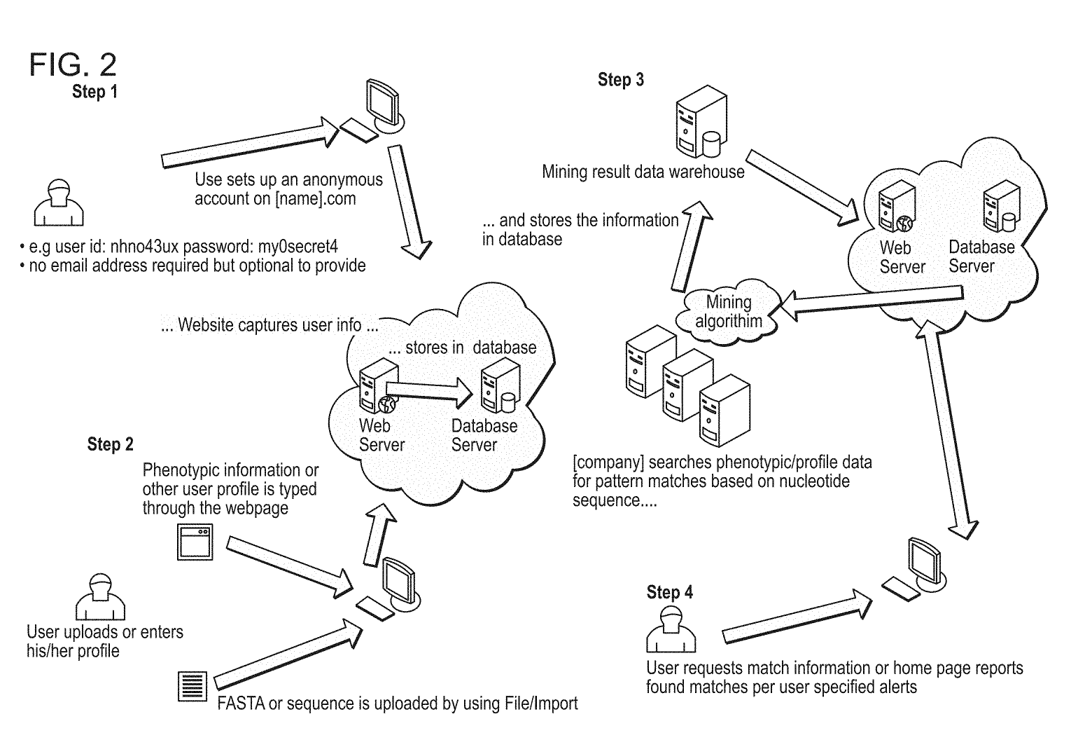

As shown in FIGS. 1 and 2, a user may set up and create an account on a website. In some embodiments, an account includes a user ID and password. In other embodiments, an account includes a plurality of information. This information may include, but is not limited to, phenotypic information such as age, sex, ethnicity and race, and personal information such as school and work information, hobbies and interests. In other embodiments, the information provided further comprises biographical and/or demographic information, such as country, region, city or town of residence, and marital status. In some embodiments, phenotypic information and/or other user profile information is directly typed into the webpage or graphic user interface (GUI) and then saved directly to the web servers and/or database servers. In some embodiments, the user interface may be any device capable of presenting or displaying data, including, but not limited to, personal computers, cellular telephones, smart phones, television sets or hand-held “personal digital assistants.” In some embodiments, a plurality of graphical user interface displays are presented on a plurality of user interface devices connected to an apparatus via the Internet. In other embodiments, the account is anonymous and only accessible to the user. In some embodiments, the website server captures the user information and stores that data on one or more database servers. It is within the scope of the invention that an individual can log on to a website page and access his/her personal information.

### (b) Nucleic Acid Sequence

In one embodiment and shown in FIGS. 1 and 2, the user uploads a nucleic acid sequence. In some embodiments, the nucleic acid sequence is previously stored on a server. In other embodiments, the nucleic acid sequence is transferred from one server to a different server. In some embodiments, genotypic information is uploaded to the web server in any one of many ways known to those skilled in the art. In one embodiment, a FASTA or sequence file is directly uploaded. In another embodiment, digital sequence information is uploaded from a user's personal computer to a database server. This includes, but is not limited to, any number of means possible known to those skilled in the art and already previously defined. In certain embodiments, the sequence information may be on an external device or drive or internal device or drive. In other embodiments, the sequenced nucleic acid is stored on a drive in a personal computer or server. In other embodiments, the sequenced nucleic acid is stored on an optical storage media, such as a DVD or CD. In other embodiments, the sequenced nucleic acid is stored on media appropriate to storage of digital information, such as flash cards, universal serial bus (USB) drives, and solid state drives. In certain embodiments, the sequenced data stored on a drive or device has protection means so only the individual can access it. Some examples of protection means comprise physical locks, passwords, and 8, 16, 32, 64, 128 or higher bit encryption. In other embodiments, other data in addition to sequence data is stored. In other embodiments, the data is stored by any means necessary to provide adequate personal protection from the theft or identity theft and tailored and suitable to an individual's preference. Some individuals may prefer to have a CD or DVD of their nucleic acid sequence while others may prefer to have the information automatically stored on a server.

It is within the scope of the invention that the process of uploading an individual's nucleic acid sequence is by any suitable means known by those skilled in the art. It may be then uploaded by a variety of ways, through a variety of networks, to a variety of electronic repositories. A large database of information is compiled as more and more users register and upload their genotypic sequences. In some embodiments, parts of the system may include one or more web servers and one or more database servers connected to the web servers. In some embodiments, a user can request information based on a phenotype or profile inquiry.

In one embodiment, an individual's genome is entirely sequenced. In another embodiment, an individual's genome is partially sequenced. In other embodiments, single nucleotide polymorphisms (SNPs) are sequenced. In certain embodiments, the number of SNPs sequenced can be from about 1 to about 10,000,000. In certain embodiments, one or more chromosomes are sequenced. In certain embodiments, a person's DNA is being sequenced. In other embodiments, a person's RNA is being sequenced. In certain embodiments, the gene expression levels are being measured. In some embodiments, the source of nucleic acid is from an individual's cell, cells, tissue, tissues, bodily fluids, skin, urine, saliva, blood, or hair.

### (c) Query

In certain embodiments, the user can run a query, also depicted in FIGS. 1 and 2. In one embodiment, an individual enters a query for informational needs. In other embodiments, the query is based on phenotypic information about an individual or individuals. In other embodiments, the query is based on genotypic information about an individual or individuals. In other embodiments, an interface allows an individual to broaden or narrow their query. This may be accomplished by any number of ways including, but not limited to, combining with previous queries, using limiting parameters, and asking for additional information.

Without being limited, the following are examples of queries that may be used in the present invention. However, it will be appreciated that any query relating to social networking is contemplated by the instant invention. For example, a user may want to find individuals who are 20 years older than himself/herself and are most similar to him or her from a genetic perspective. This way the user may correspond with the identified individuals on health related experiences and begin to think about exploring preventative measures from a health related perspective. In another example, the user may ask the question about what career path may they most be happy with pursuing. In that case the algorithm would match the user with individuals who are most similar to himself/herself from a genetic standpoint and then determine job satisfaction feedback. The user may find that, for example, the overwhelming majority of users most similar to him/her genetically are happiest in the field of science. In another example, the user may run a query in order to find a mate that is most compatible with himself/herself. The query would first ascertain who is most similar to the user from a genetic perspective and would then determine which of these users are happy in their relationships. The query would then determine which of these individuals had their mates genetic sequences uploaded and would then interrogate whether there is any genetic commonality in the mates. If a sequence commonality is determined in the mates of the individuals satisfied in their relationships then the query would return a list of individuals, to the user, that meets this criteria and are open to new relationships.

### (d) Running an Algorithm

One aspect of the invention comprises running an algorithm based on a query to return a cohort. Another aspect of the invention comprises comparing the nucleic acid sequence between the individual and one or more members of the cohort. In certain embodiments, a mining algorithm searches for phenotypic or profile data for pattern matches based on nucleotide sequence. In other embodiments, this information is sent to the web server to be displayed on a user's computer. In other embodiments, a user may also request to have alerts set up for specific and specified matches. Further explanation of the algorithm is given in detail below.

### IV. Algorithms and Factors

### Overview

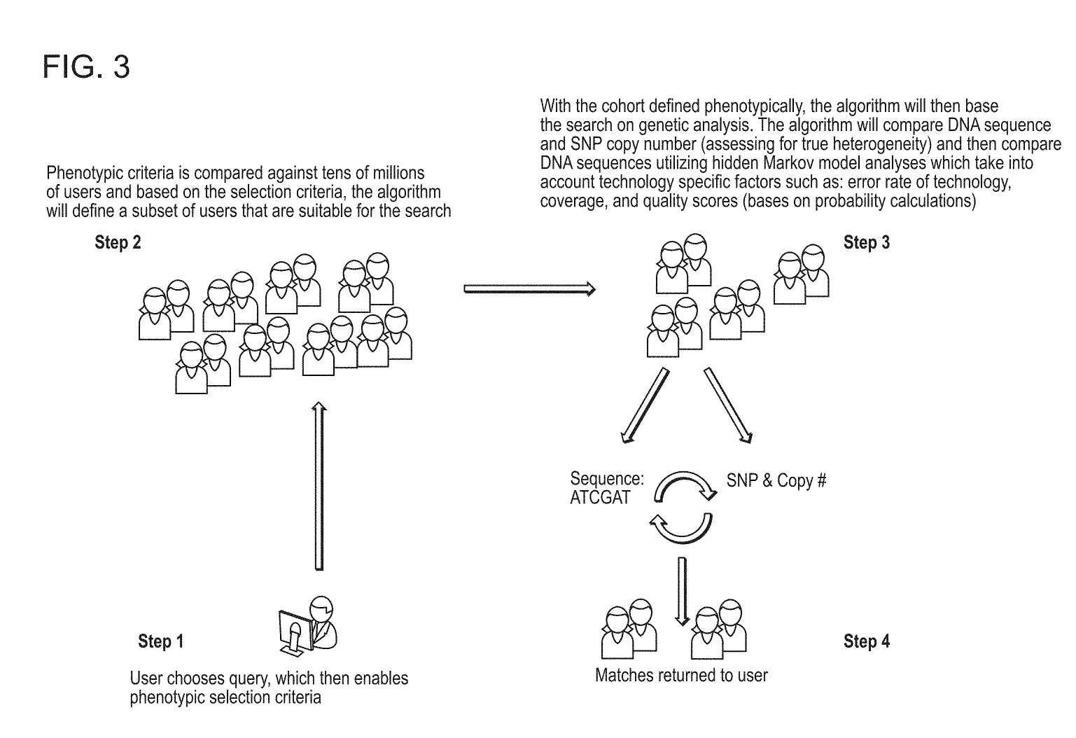

The example used in FIG. 3 shows one embodiment of the invention. Expression based data is digitally converted and then rank ordered based on expression level. In one embodiment, an algorithm is run and selects biologically relevant genes based on the phenotypic trait that an individual queried. The predictive algorithm component determines a fit for and matches the genes based on the phenotypic trait among a population. A software program may, for example, report to the individual the type of fit into the phenotypic class in question and available matches.

In some embodiments, the algorithm comprises the following components for selection of subsets and analysis of genes in expression based experiments: cohort selection (based on phenotypic data), hierarchal clustering on intensity based measurement technology or digital readout prioritization, and class determination based on genes that are impedance matched and serve as surrogate biomarkers for phenotypic states. With the genes selected that distinguish among “classes,” in some embodiments, a further subset of genes from each class are chosen using biological insight, also comprising the following variables: expression level (signal intensity from intensity based technologies), conversion algorithm if intensity based or if technology is from a digital source, the data are normalized as needed, biological insight to determine the subset of genes in each class to be used taking into account the variables below, determination of differential expression level of the genes, and predictive algorithm components.

In some embodiments, the user inputs a file that contains the signal intensity values for each gene so that a converted normalized equivalent value can be determined by having the algorithm apply a conversion factor to the inputted value in the file (each technology has its own conversion factor associated with it) which converts the input from an intensity based experiment to a normalized equivalent.

In some embodiments, the user inputs a file that contains either his/her entire DNA sequence or parts thereof. The algorithm will then first determine which individuals match the user from a phenotypic standpoint most closely. The algorithm will then assess which individuals match the user most closely from a genetic standpoint.

### Gene Expression Algorithm Factors

As the cost of generating gene expression data drops, gene expression profiling may come within the reach of the average consumer. Microarrays and new sequencing technologies allow for the profiling of over 30,000 transcripts per experiment and in some embodiments, enable individuals with a full gene expression profile to select a subset of genes from their expression profile. In other embodiments, individuals utilize this subset for the purpose of determining a match to other individuals or groups. In some embodiments, the data in this profile may be generated directly from mRNA or from cDNA.

Nucleic acid arrays that are useful in the present invention include those that are commercially available from, for example, Affymetrix (Santa Clara, Calif.) under the brand name GeneChip™.

Gene expression data, unlike the data obtained from a germ line DNA sequence or SNP profiling, is dynamic and indicative of a “state” of an individual at a snapshot in time. Therefore, as one ages the relevance of matching to a particular group or individual changes since the gene expression profile changes.

Another embodiment of the invention involves “matching” individuals to various “classes” based on a subset or signature of gene expression signatures derived from a larger gene expression profile.

Table 1 below outlines the various components of an algorithm and the criteria used for gene selection.

TABLE 1
Components of the Algorithm

| Gene Expression Considerations of Algorithm | Definition |
|---|---|
| Class Determination Algorithm Component | Tool included in the algorithm to analyze a |
| | gene expression signature and assign an |
| | individual to a class |
| Expression Level | Readout of estimated expression level, for |
| | example, signal intensity from a microarray |
| | or numbers from digital gene expression |
| | data |
| Differential Expression between Chosen Genes | Relative or quantitative difference between |
| | gene expression levels comparing the |
| | individual in question to: an individual, |
| | group of individuals, or some pre- |
| | determined standard |
| Signature Conversion Algorithm Component | Tool in the algorithm which converts an |
| | intensity based signature into a quantitative |
| | format, and similarly converts a |
| | quantitative signature to a normalized |
| | equivalent |

### Class Determination Component

In some embodiments, the class determination component of the algorithm determines the correct subset of genes, to be used for matching, from a microarray experiment or a quantitative readout expression experiment. Generally and in some embodiments, clinically based expression-profiling studies begin with samples obtained from patients in well-defined groups, and such a priori knowledge is useful in analyzing data. For example, an investigator may know that an initial data set was derived from patients with acute lymphoblastic leukemia and patients with acute myeloblastic leukemia. The first need is to identify which genes best distinguish the two classes of patients in the data set—this would establish a subset of genes and their corresponding expression values that best characterize each class.

In some embodiments, a wide variety of statistical tools are utilized, including t-tests (for two classes) and analysis of variance (ANOVA; for three or more classes). With the use of these tools, p-values are assigned to genes on the basis of whether the genes distinguish the groups of samples. Although these statistical methods are widely used, they suffer from the problem of multiple testing. For instance, because the number of samples typically included in an analysis is in the tens or hundreds and the number of genes is in the thousands, there are generally too few samples to constrain the selection of genes. As a result, even at 95% confidence (p≤0.05), on an array of 10,000 elements, 500 significant genes may be found purely by chance. Clearly, greater stringency is needed to establish criteria for gene selection, but it should also be understood that the p-values are useful for prioritizing genes for further study.

The multiple-testing problem is based on the measurement of a large number of variables that are independent of one another in a population of samples that is small relative to the number of variables. However, measurements in gene expression are not always independent, since genes map to networks and pathways in which expression is regulated in a coordinated fashion. Currently, scientists do not have a full understanding of the relationships among genes and other factors that influence coordinated patterns of expression. So, the appropriate correction for multiple testing remains an area of active research and criteria for selecting particular genes for study need to be established. It should be understood that the p-values are useful in some embodiments in prioritizing genes for investigation. In some embodiments, a collection of genes selected can be used for a variety of purposes. In other embodiments, such genes provide insight into the mechanistic aspects of a phenotype in question (having these mechanistic biomarkers may not be possible for class identification if the dynamic range of the technology used for the initial customer expression profile is not wide enough). In other embodiments, the algorithm utilizes genes that are impedance matched and serve as surrogate biomarkers for a phenotypic state or class.

### Predictive Algorithms

In some embodiments, a set of genes and their expression patterns in an initial set of users are used to classify users into groups or with direct matches, from larger gene expression data. In some embodiments, the gene expression data is digital or intensity based. In other embodiments, the algorithm component for classification is “trained” with the examples of the various phenotypes. In some embodiments, the expression vectors (i.e. the pattern of gene expression in samples) of the discriminatory genes, chosen as the “classifiers,” are used to train the selected algorithm in order to optimize its discriminatory power. In some embodiments, the result is a computational rule that is applied to a new sample and is assigned to one or more of the biologic classes. In some embodiments, the trained algorithm is applied to a test set of samples to assess its sensitivity and specificity. In other embodiments, the invention creates new classifiers for each phenotype in query.

In one embodiment, interpretation of the measurements depends on evaluation of the signature as a whole, as opposed to considering “instances” of genes. A gene signature may not exactly match a particular signature from a specific “state.” In some embodiments, predictive algorithms measure the minimum distance from a signature to that of a particular state. In some embodiments, the algorithm can then assign to it a “state” or not. For example, the most commonly used algorithm for this purpose is the K Nearest Neighbor (KNN) algorithm. The KNN algorithm works based off the weighting system from the classifiers to produce an impedance based matching system.

Table 2 below outlines the classifiers and training sets as described previously.

TABLE 2
Requirements for the Predictive Algorithm

| | Requirement |
|---|---|
| Classifiers | “Classifier” algorithms for each disease state screened for |
| | (based on the selected genes) that work in conjunction with |
| | the KNN approach |
| Training Sets | Training sets of data that can be applied to correctly train |
| | the algorithm |

### Current Limitations of the Status Quo for Determining Trait Association

Current DNA testing service companies base associations of disease risk, or genetic lineage, from either SNPs or STRs (short tandem repeats) from the literature. After an individual has been genotyped across some number of markers (e.g. 500 k SNPs), the DNA testing service company simply determines whether a SNP (from published literature) is present in the genomic code of the individual.

Limitations of genome-wide studies in the literature, on which the DNA testing services base their assumptions about disease risk, are the high cost and significant effort required to genotype hundreds of thousands of SNPs per individual. Because of the high cost, there is pressure to limit the sample size, with a consequent reduction in power. However, because variants that contribute to complex traits are likely to have modest effects (or may be rare alleles), large sample sizes are crucial. The sample sizes required are further increased by the large number of hypotheses that are tested in a genome-wide association study, because p-values must be corrected for multiple-hypothesis testing.

It has been proposed that a p-value of 5.0×10⁻⁸ (equivalent to a p-value of 0.05 after a Bonferroni correction factor for 1 million independent tests=0.05×1/1×10⁶) is a conservative threshold for declaring a significant association in a genome-wide study. To understand the consequences of this threshold, the following is given by way of an example. An allele with a frequency of 15% and an odds ratio of 1.25 (similar to that of the PPARG Pro12Ala variant associated with Type 2 diabetes). For such a variant, assuming that the causal SNP (or another SNP that serves as a perfect proxy) has been typed, nearly 6,000 cases and 6,000 controls are required to provide 80% statistical power to detect associations with a p-value of 5.0×10⁻⁸. For 500,000 independent SNPs, this sample size would require 6 billion genotypes, which would be prohibitively costly. Sample sizes smaller than this risk missing the association. The majority of association studies, on which DNA service testing companies base association information, do not contain enough samples to adequately power studies and pick rare alleles or alleles with modest effects which contribute to the trait.

Current DNA testing service companies are basing queries into genomic code, on the assumption of published association studies being complete and deterministic, although the studies are most likely not since the validity of the biomarkers are based on a limited number of patients. In order to accurately power association studies and in order to detect variants with modest effects as well as rare variants, multiple parameters must be considered in order to choose the correct number of samples at a significance level that is meaningful.

The parameters that are most relevant to association studies comprise trait prevalence in the population, minor allele frequency, and genotype relative risk of an allele.

TABLE 3
Example of Sample Size Limitation Study

| | Trait | | | | |
|---|---|---|---|---|---|
| Trait | Prevalence | MAF* | Relative Risk | Samples | Power |
| Allele A | 5% | 10% | 1.2 | 20K | 45% |
| Allele B | 10% | 1% | 1.1 | 20K | Not Detected |

*MAF = minor allele frequency

The example given in Table 3 above denotes a possible false association, due to underpowered sample size that may be reported to a user of DNA testing service and a rare allele (1%) that may contribute, or may be the causative allele, to 10% of a population in gaining a particular trait (e.g. athletic prowess).

The current invention would have millions of users with their DNA sequences, or parts thereof, contained within the database. Thus the examples shown in Table 3, would be powered at >99.9%. Given the large sample size on which the algorithm has to run the query, it is feasible that traits that are prevalent in a very small percentage of the population may be queried with confidence, thus allowing users to feel confident that the individuals they are matched to are indeed their correct genetic matches.

### DNA Matching

One embodiment of the present invention allows a user to input one or more phenotypic criteria in order to narrow down the number of individuals that will be compared. In other embodiments, the genetic code is analyzed against a group of individuals with similar phenotypes. In another embodiment, the genetic code is analyzed against a broader, control group that matches closely to the queried phenotype, but lacks that trait.

It is within the scope of this invention that the majority of traits users search for are a match containing one or more rare alleles. In another embodiment, the search may be for a match containing common alleles that contribute to the phenotype and, in combination, provide the genetic predisposition to that trait.

In some embodiments, a model is used whereby individuals may be first grouped according to phenotype. In some embodiments, a phenotypic trait search is based on another phenotypic trait. For example, sex, gender, ethnicity, body mass index, a trait in question, or another general genetic similarity search can be based on an age group. The advantage of this is to provide a phenotypic component to the search that narrows the cohort against which the user is compared. This comprises a phenotypic component to the search as well as allowing for genetic analysis.

In some embodiments, the algorithm assesses SNPs and copy number to assess for true heterogeneity. A problem in the prior art is that often, sequencing technologies provide amplification bias of one strand over another. Furthermore, unless there is very deep coverage, a true heterozygote for a particular locus may be mistakenly called as a homozygote, as the few instances of difference that exist between the strands will be deemed as errors. In certain embodiments, SNP copy number analysis is provided in conjunction with DNA sequence analysis. This way, the algorithm will be orders of magnitude more accurate than standard sequence alignment algorithms in the prior art.

### Algorithm Matching

The following discloses a process of the steps the algorithm takes in order to assess genetic matches. In some embodiments, the starting point of the process is a step whereby the user chooses a query to run. In other embodiments, the phenotypic portion of the algorithm compares the individual user's phenotype against that of the entire user community including matching for the trait in question. For example, if there was a query for “Type A” personality then the algorithm may match the users to all other users of similar age, race, sex, and trait in question (i.e. Type A personality). In another embodiment, the algorithm defines a control matched population. For example, those users who match in age, race, sex, but not for the Type A personality trait.

In some embodiments, the algorithm conducts a genetic analysis comparing DNA sequence information, using a Hidden Markov Model (HMM) analysis combined with SNP copy number comparison, to compare samples within each group. In some embodiments, the algorithm comprises determining the genetic matches closest to the user and compares it against the control group to determine statistical significance.

In one embodiment, the whole genome sequence is partially provided. In another embodiment, the algorithm makes use of comparing various subsets of genes that are uploaded and the use of available SNP information. In other embodiments, if the algorithm determines that there is not an appropriate amount of genetic information provided, it returns a “Cannot Conduct” Search or similar message.

One of skill in the art would appreciate that open-source tools exist that can handle large data sets and whole-genome associate studies. For example, PLINK is an open-source tool that is designed to handle large data sets and whole-genome association studies (WGAS).

### Association Studies

The following are common deliverables that consumer genomics may provide to clients in terms of both SNP and DNA sequence information. It is within the scope of this invention that the algorithm works with minimal amounts of information in each of the cases below.

### (i) Whole Genome SNP Association Studies

Whole genome SNP association studies, in some embodiments, involves the comparison of a predetermined SNP marker set ranging from about 10,000 to about 10,000,000 SNPs between case and control cohorts. In some embodiments, allele frequency differences at various loci between populations are determined and deemed “hits” where significant differences arise between the case and the control. This category of association study has been referred to as a Genome Wide Scan (GWS). Either the SNP data may be uploaded for the algorithm to run correctly, or the sequences from the genes determined as “hits” from the GWS may be uploaded. Table 4 below shows the number of genes likely to be sequenced based on different genomic regions.

TABLE 4
Number of Genes Sequenced for Algorithm to Function from GWS SNP Association
Studies

| | |
|---|---|
| Genes Returned as “Hits” From GWS SNP | Number of Genes Likely to Be Sequenced for |
| Association Studies | the Algorithm to Work (Defined in Whole |
| | Gene Sequence as well as Exonic Region |
| | Sequence) |
| Whole Gene Regions | |
| Numbers of Candidate Genes (Introns and | Range of the Number of Genes: 50-200 |
| Exons) Resulting from Whole Genome SNP | Size per Gene: 25-300 kb + 2 kb upstream |
| Association Studies (Whole Genes) | and 3 kb downstream |
| Exonic Regions | |
| Numbers of Candidate Genes (Exonic Regions | Range of the Number of Genes: 250-700 |
| Only) Resulting from Whole Genome SNP | Average size of total exonic region per gene: 3-5 kb |
| Association Studies (Whole Genes) | |

### (ii) Candidate Gene Association Studies

In some embodiments, SNP based candidate gene studies result from genome wide association. In some embodiments, SNPs are chosen within genes that arise as “hits” from a genome wide association study (often referred to as “fine mapping”). In another embodiment, SNP based candidate gene studies result from suspect gene lists. In other embodiments, SNPs are chosen within genes that are directly or indirectly associated with the trait in question. In yet another embodiment, panels of SNPs are created around the trait or property in question.

TABLE 5
Number of Genes Sequenced from Candidate Gene
SNP Association studies for Algorithm to Function

| | |
|---|---|
| Genes Returned as | Resulting Number of Genes Likely to Be |
| “Hits” from SNP | Sequenced and Uploaded for the Algorithm to |
| Association Studies | Work Correctly (Defined in Whole Gene |
| | Sequence as well as Exonic Region Sequence) |
| Numbers for Candidate | Number of Genes: about 6-100 |
| Genes For Candidate | Size per Region: 25-300 kb + 2 kb upstream |
| Gene SNP Studies | and 3 kb downstream |
| (Whole Genes introns | |
| and exons) | |

In Table 5, the requirement for the number of genes in the algorithm is lower than in Table 4. This is due to the fact that the genes inputted in Table 5 are vetted, in the sense that they have come from prior GWS and therefore have been determined to have some prior association with a phenotype.

### Sequencing Based Candidate Gene Studies

In some embodiments with germ line DNA, sequencing based candidate gene studies take place after a number of candidate genes have been established to be associated with a trait in question. For example, these studies often occur downstream of a genome wide SNP scan where “hits” from the GWS have replicated in an alternate cohort. In another embodiment, candidate genes are chosen by their location, in a region of linkage, or on another basis that they may affect disease risk.

In some embodiments with tumor DNA, candidate gene sequencing studies are common due to the fact that SNP association studies are not feasible as the hypervariability of regions within tumor DNA prevents one from properly designing primers to accurately interrogate SNPs of interest. The Cancer Genome Atlas (TCGA) project has been designed as a candidate gene sequencing project to elucidate the sequence of suspect genes from various cancers.

TABLE 6
Number of Genes Sequenced from Candidate Gene
SNP Association studies for Algorithm to Function

| | |
|---|---|
| Genes Returned as “Hits” | Resulting Number of Genes Likely to Be |
| from Candidate Gene | Sequenced and Uploaded for the Algorithm to |
| Resequencing Studies | Work Correctly (Defined in Whole Gene |
| | Sequence as well as Exonic Region Sequence) |
| Number of Genes for | Number of Genes: 50-200 |
| Candidate Gene Diabetes | Size per Region: 25-300 kb + 2 kb upstream |
| Medical Resequencing | and 3 kb downstream |
| Study (Whole Genes) | |
| (Large Govt. Funded | |
| Project) | |

In some embodiments, the algorithm reports who the user most likely matches for a particular trait and a statistical difference which differs from the control population. In some embodiments, the report gives the user a degree of confidence regarding how closely the user matches those reported as matches. For example, the significance level determined may be a p-value of 1×10⁻⁸ and the algorithm would determine how many variables were compared and assess judgment as to whether the analysis overcame the Bonferroni correction factor. In some embodiments, the results reported to the user would not be provided as p-values but rather as confidence levels. In some embodiments, the reported confidence levels comprise High Match, Medium Match, and Low Match.

### Linkage Disequilibrium (LD) Based Markers

To be useful, markers tested for association trust either be the causal allele or highly correlated (in LD) with the causal allele. Most of the gnome falls into segments of strong LD, within which variants are strongly correlated with each other, and most chromosomes carry one of only a few common combinations of SNPs.

These studies have shown that most of the roughly 11 million common SNPs in the genome have groups of neighbors that are all nearly perfectly correlated with each other. The genotype of one SNP perfectly predicts those of correlated neighboring SNPs. One SNP can thereby serve as a proxy for many others in an association screen. Once the patterns of LD are known for a given region, a few tag SNPs can be chosen such that, individually or in multimarker combinations (haplotypes) they capture most of the common variation within the region.

A proportionally higher density of variants must be typed to comprehensively survey the fraction of the gnome that shows low LD. It has been published that a few hundred thousand well-chosen SNPs should be adequate to provide information about most of the common variation in the genome (Hirschhorn, J. Genome Wide Association Studies for Common Diseases and Complex Traits, Nature Reviews, vol: 6; February 2005; pp 95-108). A larger member of tag SNPs is likely to be required in African populations (and those with very recent origins in Africa), because these populations generally contain more variation and less LD. The precise number of tag SNPs needed is yet to be determined, and will depend on the methods used to select SNPs, the degree of long-range LD between blocks and the efficiency with which SNPs in regions of low LD can be tagged.

### Testing SNPs for Association by Direct and Indirect Methods.

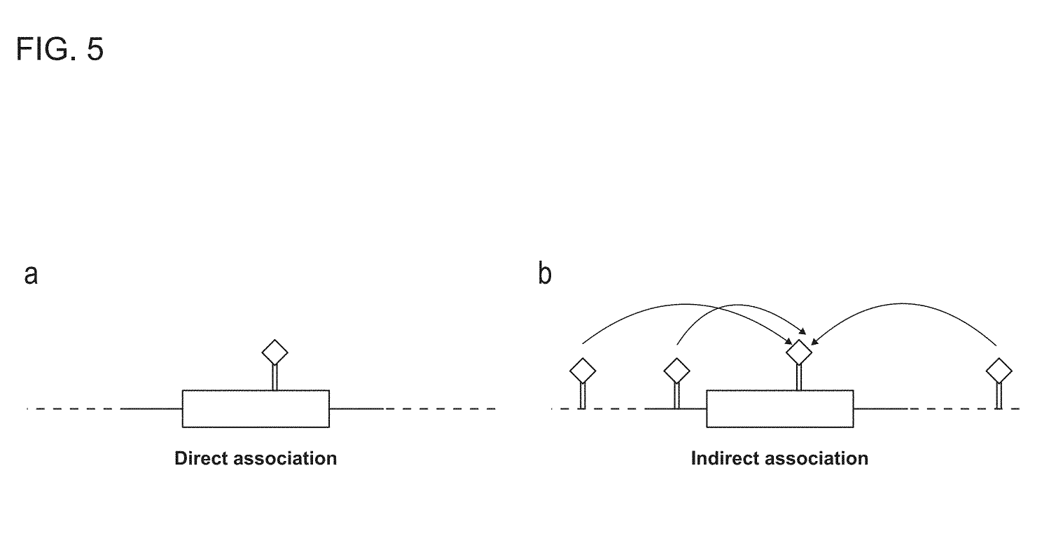

The left panel in FIG. 5 shows a case in which a candidate SNP (red) is directly tested for association with a disease phenotype. For example, this is the strategy used when SNPs are chosen for analysis on the basis of prior knowledge about their possible function, such as missense SNPs that are likely to affect the function of a candidate gene (green rectangle).

The SNPs in the right panel of FIG. 5 to be genotyped (red) are chosen on the basis of linkage disequilibrium (LD) patterns to provide information about as many other SNPs as possible. In this case, the SNP shown in blue is tested for association indirectly, as t is n LD with the other three SNPs. A combination of both strategies is also possible.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element is essential to the practice of the invention.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art.

### EQUIVALENTS

Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed.

### INCORPORATION BY REFERENCE

All of the US patents and US patent application Publications cited herein are hereby incorporated by reference.

1. A method of social networking based on nucleic acid sequence analysis comprising the steps, performed by a computer system, of:
(a) storing in a data storage system nucleic acid sequence data and user profile data for each of a plurality of users of a social networking community;
(b) receiving a query from one of said users of said social networking community for identifying one or more other users of said social networking community having given user profile characteristics and nucleic acid sequence characteristics;
(c) identifying a set of one or more users having the given user profile characteristics;
(d) comparing the nucleic acid sequence data of the user submitting the query to the nucleic acid sequence data of said set of one or more users identified in (c) to identify a subset of users having said given nucleic acid sequence characteristics; and
(e) transmitting information on said subset of users to the user submitting the query.

2. The method of social networking of claim 1, wherein said nucleic acid is DNA or RNA.

3. The method of social networking of claim 1, wherein the given user profile characteristics and nucleic acid sequence characteristics comprise user profile characteristics and nucleic acid sequence characteristics matching those of the user submitting the query.

4. The method of social networking of claim 1, wherein the given user profile characteristics and nucleic acid sequence characteristics comprise user profile characteristics and nucleic acid sequence characteristics matching the search criteria input from the user.

5. The method of social networking of claim 1, wherein the given user profile characteristics and nucleic acid sequence characteristics comprise user profile characteristics matching those of the user submitting the query and nucleic acid sequence characteristics not matching those of the user submitting the query.

6. The method of social networking of claim 1, wherein the given user profile characteristics and nucleic acid sequence characteristics comprise user profile characteristics matching the search criteria input from the user and nucleic acid sequence characteristics not matching the search criteria input from the user.

7. The method of claim 1, further comprising facilitating communication between the user submitting a query and the subset of users.

8. The method of claim 7, wherein facilitating communication comprises messaging through a website hosting the social networking community.

9. The method of claim 1, wherein said subset of users are rank ordered based on nucleic acid sequence characteristics.

10. The method of claim 1, wherein the query is based on phenotypic information.

11. A social networking system based on nucleic acid sequence analysis comprising:
a data storage system for storing nucleic acid sequence data and user profile data for each of a plurality of users of a social networking community; and
a computer server for (a) receiving over a computer network a query from one of said users of said social networking community for identifying one or more other users of said social networking community having given user profile characteristics and nucleic acid sequence characteristics; (b) identifying in the data storage system a set of one or more users having the given user profile characteristics; (c) comparing the nucleic acid sequence data of the user submitting the query to the nucleic acid sequence data of said set of one or more users identified in (b) to identify a subset of users having said given nucleic acid sequence characteristics from said set of one or more users; and (d) transmitting information on said subset of users to the user submitting the query.

12. The social networking system of claim 11, wherein said nucleic acid is DNA or RNA.

13. The social networking system of claim 11, wherein the given user profile characteristics and nucleic acid sequence characteristics comprise user profile characteristics and nucleic acid sequence characteristics matching those of the user submitting the query.

14. The social networking system of claim 11, wherein the given user profile characteristics and nucleic acid sequence characteristics comprise user profile characteristics and nucleic acid sequence characteristics matching the search criteria input from the user.

15. The social networking system of claim 11, wherein the given user profile characteristics and nucleic acid sequence characteristics comprise user profile characteristics matching those of the user submitting the query and nucleic acid sequence characteristics not matching those of the user submitting the query.

16. The social networking system of claim 11, wherein the given user profile characteristics and nucleic acid sequence characteristics comprise user profile characteristics matching the search criteria input from the user and nucleic acid sequence characteristics not matching the search criteria input from the user.

17. The social networking system of claim 11, wherein said server facilitates communication between the user submitting a query and the subset of users.

18. The social networking system of claim 17, wherein said server facilitates messaging through a web site hosted by the server.

19. The social networking system of claim 11, wherein said subset of users are rank ordered based on nucleic acid sequence characteristics.

20. The social networking system of claim 11, wherein the query is based on phenotypic information.

21. A computer-implemented social networking system based on nucleic acid sequence analysis comprising:
a repository for nucleic acid sequence data and user profile data for each of a plurality of users of a social networking community; and
a computer server system including one or more processors configured for (a) receiving over a computer network a query from one of said users of said social networking community for identifying one or more other users of said social networking community having given user profile characteristics and nucleic acid sequence characteristics; (b) accessing the repository to identify a set of one or more users having the given user profile characteristics; (c)) comparing the nucleic acid sequence data of the user submitting the query to the nucleic acid sequence data of said set of one or more users identified in (b) to identify a subset of users having said given nucleic acid sequence characteristics from said set of one or more users; and (d) transmitting information on said subset of users to the user submitting the query.

22. The social networking system of social networking of claim 21, wherein said nucleic acid is DNA or RNA.

23. The social networking system of claim 21, wherein the given user profile characteristics and nucleic acid sequence characteristics comprise user profile characteristics and nucleic acid sequence characteristics matching those of the user submitting the query.

24. The social networking system of claim 21, wherein the given user profile characteristics and nucleic acid sequence characteristics comprise user profile characteristics and nucleic acid sequence characteristics matching the search criteria input from the user.

25. The social networking system of claim 21, wherein the given user profile characteristics and nucleic acid sequence characteristics comprise user profile characteristics matching those of the user submitting the query and nucleic acid sequence characteristics not matching those of the user submitting the query.

26. The social networking system of claim 21, wherein the given user profile characteristics and nucleic acid sequence characteristics comprise user profile characteristics matching the search criteria input from the user and nucleic acid sequence characteristics not matching the search criteria input from the user.

27. The social networking system of claim 21, wherein said server facilitates communication between the user submitting a query and the subset of users.

28. The social networking system of claim 27, wherein said computer server system facilitates messaging through a website hosted by the computer server system.

29. The social networking system of claim 21, wherein said subset of users are rank ordered based on nucleic acid sequence characteristics.

30. The social networking system of claim 21, wherein the query is based on phenotypic information.
